(19) United States
(12) Patent Application Publication
(10) Pub. No.: US 2020/0050534 A1
(43) Pub. Date: Feb. 13, 2020

(54) SYSTEM ERROR DETECTION

(71) Applicant: Google LLC, Mountain View, CA (US)

(72) Inventors: Shing Franky Sze, Manhasset, NY (US); Ian Harrington Blakley, New York, NY (US); Ian Maxwell Barefoot, New York, NY (US); Shaoqing Yang, Hoboken, NJ (US)

(21) Appl. No.: 16/100,491

(22) Filed: Aug. 10, 2018

(51) Int. Cl. G06F 11/36

(52) U.S. Cl. CPC G06F 11/3612; G06N 99/005; G06F 11/3616

(57) ABSTRACT

Methods, systems, and apparatus, including computer programs encoded on computer storage media, for detecting system errors. One of the methods includes collecting an event log for the execution that identifies automated interactions with the application performed by an application testing agent; storing the event log in one or more content storage devices; storing event tracking data captured by a third party system during the automated interaction; comparing the first parameter types with the second parameter types to determine whether expected parameter types from the first parameter types are included in the second parameter types; comparing the corresponding first parameter values with the corresponding second parameter values for the same parameter type to determine whether the corresponding values are the same; and detecting a software error in one or more of the application, the third party system, or the event collection apparatus.

### BACKGROUND

Some systems receive data from a third party system that are used to generate output. For instance, a machine learning system may receive training data from a third party system that is used to train an artificial intelligence system. The system may receive the training data from the third party system when the system is prevented from running a script in an environment of the third party system. For example, when the third party system is for a publisher that prevents executing of java script, e.g., in a native application or on a webpage, the system may receive metrics for other systems from the third party system.

### SUMMARY

In some implementations, when a system receives metrics data from a third party system that are generated through execution of an application, the system can execute automated tests of the application to create test metrics. The system can use the test metrics to verify that metrics received from the third party system are correct, that there is not likely a software error for the application, or both. For instance, the system may use a user interface automation-testing interface, e.g., Android Instrumentation Tests or Xcode UI Test (XCUITest) framework for iOS, to execute multiple test interactions with the application to cause the third party system to generate test metrics for the test interactions.

When the system receives the test metrics from the third party system, the system can compare the test metrics with expected metrics given the particular test interactions that were executed. The system can use a result of the comparison to determine whether an error occurred during execution of the application, e.g., when the test metrics are not the same as the expected metrics. If an error occurred, the system may determine that the application, the third party system, or the system should be updated to correct the error.

Some example errors may include when the third party metrics do not identify an execution of the application or metrics that indicate more or fewer interactions with the application than actually occurred. When the system identifies one of these errors, the system may determine whether metrics are being recorded incorrectly, there is a bug in the application, or both. In some implementations, the system may automatically perform a corrective action, e.g., to fix the bug.

In general, one innovative aspect of the subject matter described in this specification can be embodied in methods that include the actions of collecting, by an event collection apparatus and for each of a plurality of executions of an application on a device, an event log for the execution that identifies automated interactions with the application performed by an application testing agent on the device, each event log comprising, for each of multiple automated events that occurred on the device in response to one or more of the automated interactions, one or more first parameter types and, for each of the first parameter types, a corresponding first parameter value; storing, by the event collection apparatus and for each of the plurality of executions of the application on the device, the event log in one or more content storage devices; storing, by the event collection apparatus and for one or more of the plurality of executions of the application on the device and in the one or more content storage devices, event tracking data captured by a third party system, separate from an event verification apparatus, during the automated interaction with the application on the device by the application testing agent, the event tracking data comprising, for each of at least some of the multiple automated events that occurred on the device, one or more second parameter types and, for each of the second parameter types, a corresponding second parameter value; comparing, by the event verification apparatus and for some of the plurality of executions of the application, the first parameter types with the second parameter types to determine whether expected parameter types from the first parameter types are included in the second parameter types; comparing, by the event verification apparatus and for each of the expected parameter types that are included in the second parameter types, the corresponding first parameter values with the corresponding second parameter values for the same parameter type to determine whether the corresponding values are the same; and detecting, by the event verification apparatus, a software error in one or more of the application, the third party system, or the event collection apparatus in response to determining that i) at least one of the expected parameter types from first parameter types is not included in the second parameter types, ii) at least one of the corresponding values is not the same, or iii) both i and ii. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method may include receiving, via a network from a device, an event log generated by the device during automated interaction with an application on the device; and storing, in the one or more content storage devices, the event log. The method may include receiving, via a network from the third party system, the event tracking data; and storing, in the one or more content storage devices, the event tracking data. The third party system may prevent the application from executing scripts from other systems, including the event collection apparatus and the event verification apparatus, during execution of the application. The application may be a web-based application.

In some implementations, the method may include selecting, from a database of multiple test scripts, a test script that identifies multiple automated interactions with the application; providing, to the device, the test script to cause the application testing agent to perform one or more of the multiple automated interactions with the application; and receiving, from the device, a message indicating that the application testing agent executed the test script. Collecting, for at least one of the plurality of executions of the application on the device, the event log may include selecting a log that identifies the multiple automated events that execution of the test script by the application testing agent is likely to cause to occur on the device; and in response to receiving the message indicating that the application testing agent executed the test script, using the selected log as the event log for the execution of the test script by the application testing agent. Collecting, for at least one of the plurality of executions of the application on the device, the event log may include receiving the event log from the device that the application testing agent created concurrently with execution of a test script that defined multiple automated interactions for the application testing agent to perform with the application. The method may include providing, to the device, a test script that identifies specific automated interactions for the application testing agent to perform to test a particular type of event in the application. The method may include providing, to the device for each event type in a plurality of event types, a test script that identifies specific automated interactions for the application testing agent to perform to test the corresponding event type in the application.

In some implementations, the method may include determining that the one or more content storage devices include an event log for a particular execution of the application from the plurality of executions; determining that the one or more content storage devices do not include event tracking data for the particular execution of the application that was captured by the third party system; and in response to determining that the one or more content storage devices include an event log for a particular execution and determining that the one or more content storage devices do not include event tracking data for the particular execution, detecting a software error for the application or the third party system or both. Detecting the software error may include determining a potential location of a software error using i) the at least one of the expected parameter types from first parameter types is not included in the second parameter types, ii) the at least one of the corresponding values is not the same, or iii) both i and ii. The method may include, in response to determining the potential location of the software error, sending, to a software debugging system, data that identifies the potential location of the software error. The method may include, in response to determining the potential location of the software error, sending, to a software debugging system, data that identifies the potential location of the software error to cause the software debugging system to automatically, without human input, correct the software error.

The subject matter described in this specification can be implemented in various embodiments and may result in one or more of the following advantages. In some implementations, the systems and methods described below may verify that data gathered by a third party system was correctly captured. This can be particularly helpful in situations where the third party system will not allow the system to execute, within the third party system, scripts that would allow the system to directly monitor (or detect) the data gathered by the third party system. The data gathered by the third party system may be training data for a machine learning system, content presentation data that identifies content presented to a user, data that indicates user interaction with presented content, or a combination of two or more of these. For instance, an application analysis system may compare application execution data, e.g., event data, generated during execution of a test script to verify that a third party system correctly captured data during execution of the application. In some implementations, the systems and methods described below can improve an application debugging system by helping identify a software bug location in an application, a metrics gathering system, or both. In some implementations, the systems and methods described in this document can catch regressions during software updates, e.g., detect a bug in an application after an update to the application. In some implementations, the systems and methods described in this document may increase the accuracy of metrics data. For instance, a system can compare data gathered by multiple different systems, e.g., different third party systems, different application analysis systems, or both, to determine whether there is a variance in data captured by the different systems and a potential error, error location, or both, when there is a data variance.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in which an application analysis system tests execution of an application developed by a publisher.

FIG. 2 is a flow diagram of a process for detecting a software error.

FIG. 3 is a block diagram of a computing system that can be used in connection with computer-implemented methods described in this document.

Like reference numbers and designations in the various drawings indicate like elements.

### DETAILED DESCRIPTION

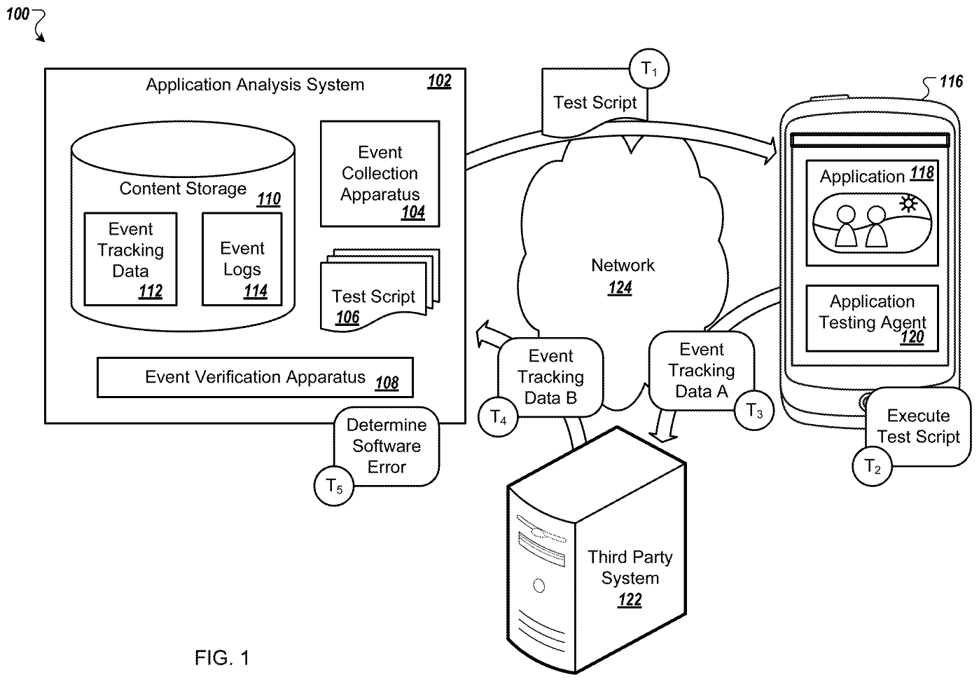

FIG. 1 is an example environment 100 in which an application analysis system 102 tests execution of an application developed by a publisher, e.g., a separate publisher. The results of application execution may be used during a machine learning process, e.g., to train an artificial intelligence, during analysis of the application, or both. In some examples, the application analysis system 102 may test execution of an application developed by an entity that controls the application analysis system 102 in an environment in which the application analysis system 102 cannot run separate scripts within the application.

The application analysis system 102 includes an event collection apparatus 104 that sends one or more test scripts 106 to various devices to test applications executing on the devices. The test scripts 106 define one or more steps for the various devices to perform to test an application on the device. For instance, a test script 106 may define one or more operations, e.g., user interface interactions, for the device to perform with an application executing on the device. Some of the operations, or combinations of the operations, cause the device to generate tracking data that identifies events in the application caused by the user interface interactions. Some examples of events include image impressions, whether a comment was made, whether a user interface element was selected, e.g., with a mouse click or touch screen input, or another event in the application.

The application analysis system 102 can compare expected event data that is expected to be generated when using a test script with actual event data captured by a third party system, e.g., an event tracking system such as an advertisement verification system or a machine learning verification system. The application analysis system 102 can use a result of the comparison to detect a software error in the application or another portion of the environment 100, for example, when the actual event data reported by the third party system does not match the expected event data that was expected to be generated when using the test script.

For example, during time period T₁, the application analysis system 102 sends one or more test scripts 106 to a device 116. The event collection apparatus 104 can retrieve multiple test scripts 106 from one or more memories included in the application analysis system 102 and send the retrieved test scripts to the device 116.

The device 116 may be any appropriate type of device, such as a desktop computer, a mobile device, e.g., a smartphone, a virtual device, or a combination of two of these. For instance, the device 116 can be a virtual machine executing on a physical device. The virtual machine may simulate actual execution of an application 118 on the device 116 to test a real-world environment. In some examples, the device 116 may be part of the application analysis system 102, e.g., the virtual machine may execute on a computer included in the application analysis system 102. In some examples, the device 116 may separate from the application analysis system 102. For instance, the device 116 may be a virtual machine on a device separate from the application analysis system 102 or may be a separate computer from one or more computers included in the application analysis system 102.

The device 116 includes an application testing agent 120, e.g., a computer-implemented agent, that executes the received test scripts 106 to test an application 118 executing on the device 116. The application testing agent 120 can be an automated agent that executes one or more of the received test scripts 106 automatically, e.g., without user input. The device 116 may launch, or open, the application 118 upon receipt of the test scripts 106. The application 118 may be any appropriate type of application, such as a native application specific to an operating system of the device 116, a web application, or another type of application.

During time period T₂, the application testing agent 120 executes some or all of the received test scripts 106. The application testing agent 120 may perform one or more operations defined in the received test scripts 106. For instance, when the application 118 includes a user interface, the application testing agent 120 can perform user interface interactions with the application 118 based on the operations defined in the received test scripts. The user interface interactions may include selection of menu items, selection of a link, selection of a user interface element to create a comment, or another appropriate interaction that is part of a process that can generate event tracking data.

The application testing agent 120 executes the test scripts 106, e.g., a set of predefined operations, outside of the application 118 to cause the application 118 to generate event tracking data that is sent to a third party system 122. For example, the application testing agent 120 may be an application separate from the application 118. Execution of the test scripts 106 by the application testing agent 120 cause the application testing agent 120 to interact with the application 118, e.g., with the user interface of the application 118. The interaction with the application 118 causes the application 118 to generate event tracking data that can be compared with expected event data, e.g., to determine whether a software error occurred.

In some examples, the application testing agent 120 may be part of a user interface automation testing interface that executes test interactions with various applications including the application 118. For example, the application testing agent 120 may be part of the Android Instrumentation Tests or the Xcode UI Test (XCUITest) framework for iOS.

Execution of the test scripts 106 on the device 116 causes the device 116, during time period T₃, to generate and provide event tracking data A to a third party system 122. For example, the application 118 includes code that defines events for which the application 118 provides tracking data to the third party system 122. When the application 118 receives input, e.g., based on the user interface interactions performed by the application testing agent 120, the application 118 may perform some of these events, e.g., an image impression or comment creation. After some events occur, the device 116, e.g., the application 118 executing on the device 116, can provide event tracking data A that identifies the events to the third party system 122, e.g., an event tracking system.

For instance, when the application testing agent 120 performs operations that cause presentation of content in a user interface of the application 118, the application 118 may request a tracking pixel from the third party system 122. The third party system 122 can use the requested tracking pixel to determine the content presented in the application 118, content generated by the application 118, or other events in the application 118, caused by the operations performed by the application testing agent 120.

The device 116, e.g., the application 118, might generate event tracking data for only some events for the application 118. For instance, the application 118 may generate tracking data for presentation of a video or a comment box but not for presentation of an overall menu for the application. In some implementations, events for which the device 116, e.g., the application 118, generates event tracking data may be customized using settings for the device 116, the application 118, or both. For example, the customizable settings may define for which events the device 116 should generate event tracking data.

As described above, the application 118 does not allow execution of a script, developed by a party other than a publisher of the application 118, within the application 118 to generate tracking data. Instead, the application 118 provides tracking data to the third party system 122, e.g., based on the code included in the application 118. Preventing execution of scripts developed by other parties within the application 118 may increase security of the application 118, improve processing time for the application 118, e.g., by not requiring execution of additional operations, or both.

After the third party system 122 receives the event tracking data A from the device 116, the third party system 122 can analyze the event tracking data A. During the analysis of the event tracking data A, the third party system 122 can generate event tracking data B, e.g., a subset of the event tracking data A. The third party system 122 provides, during time period T₄, the event tracking data B to the application analysis system 102. For example, the third party system 122 may provide all of the event tracking data A or only a portion (e.g., less than all) of the event tracking data A, as the event tracking data B, to the application analysis system 102. In some examples, the third party system 122 may access one or more rules that define the event tracking data the third party system 122 should provide to the application analysis system 102. The third party system 122 may apply the rules to the event tracking data A to generate the event tracking data B.

The third party system 122 is a separate system from the application analysis system 102. For instance, the third party system 122 may be operated by a publisher of the application 118 or another entity, different from the entity that operates the application analysis system 102. In some examples, the third party system 122 includes one or more computers separate from the computers included in the application analysis system 102.

In some implementations, a first entity controls the application analysis system 102 and the device 116 and a second, separate entity controls the third party system 122. For example, when the device 116 is a virtual machine executing on a computer included in the application analysis system 102, the first entity controls operation of the application analysis system 102 and the device 116 while the second entity controls operation of the third party system 122.

The application analysis system 102, e.g., the event collection apparatus 104 such as an event campaign manager, receives the event tracking data B. The event collection apparatus 104, e.g., an advertising campaign manager, stores the received event tracking data B in a content storage 110 as the event tracking data 112. The stored event tracking data 112 may include an identifier for the device 116 for which the tracking data was generated, a time at which the corresponding events occurred, or both.

The event tracking data 112 may include parameters for corresponding events. For instance, when an event is content retrieval, corresponding parameters may include a size of the content, e.g., in pixels, whether the content was presented on a display, when the content was presented on a display, e.g., a timestamp, whether the content is viewable in a user interface of the application 118, a device or destination location, or a combination of two or more of these.

Based on the test scripts sent to the device 116 at time T₁, the event collection apparatus 104 can store event logs 114 in the content storage 110. An event log 114 may identify expected application events, and corresponding parameters, based on respective test scripts executed by an application testing agent 120. An event log 114 may correspond to events performed by the device 116 or the application 118 given the operations defined in the one or more test scripts 106. For instance, the event collection apparatus 104 may store a first event log 114 in the content storage 110 for a first test script 106 provided to the device 116. The first event log 114 may include an identifier for the device 116, a time at which the test script 106 was provided to the device 116, event information for application events the application testing agent 120 will cause to occur upon execution of the test script 106, or a combination of two or more of these. A second event log 114 may include application events for operations the application testing agent 120 performed based on two or more of the test scripts 106.

In some implementations, some of the event logs 114 may be predetermined, e.g., based on the corresponding test scripts. In some implementations, the device 116 or another system may generate an event log for a test script executed by the application testing agent 120. The device 116 may generate a single event log for all test scripts executed by the application testing agent 120, an event log for each test script executed by the application testing agent 120, or a combination of both.

During time period T₅, an event verification apparatus 108 can use the event tracking data 112 and the event logs 114 to correlate at least some of the event tracking data 112 with corresponding event logs 114. For instance, the event verification apparatus 108 may use a device identifier, timestamps, or both, from entries in the event tracking data 112 and the event logs 114 to determine the event logs 114 for corresponding event tracking data 112.

Once the event verification apparatus 108 determines event logs 114 and corresponding event tracking data 112, the event verification apparatus 108 uses the determined event logs 114 and corresponding event tracking data 112 to detect whether a software error occurred. For example, the event verification apparatus 108 may select a portion of the determined event logs 114 that indicate events, and corresponding event parameters, for which the application analysis system 102 expects to receive event tracking data from the third party system 122. If the event verification apparatus 108 does not have event tracking data 112 for these selected events, the event verification apparatus 108 can determine that a software error likely occurred. Similarly, if the event verification apparatus 108 has event tracking data 112 for the selected events but the parameters for the events, in the event tracking data 112 and the event logs 114, are different, the event verification apparatus 108 can determine that a software error likely occurred.

When a software error is determined to have likely occurred, the event verification apparatus 108 may analyze data in the content storage 110 to determine a potential location of the software error. For instance, the event verification apparatus 108 can determine whether the software error potentially occurred in the device 116, e.g., caused by an error in the application 118, in the application analysis system 102, e.g., caused by an error in creation of the test scripts 106 or the event logs 114 or receipt of the event tracking data B or a combination of these, or the third party system 122, e.g., caused by an error in data sent to the application analysis system 102.

In some implementations, the application analysis system 102 may analyze different versions of an application, e.g., for different operating systems or different application releases or both, to determine where a software error likely occurred. For instance, the application analysis system 102 can use the same test script for two different releases of an application 118, e.g., version 1.1 and version 1.2. When the application analysis system 102 determines that a software error did not likely occur for version 1.1 of the application 118, e.g., the expected events and corresponding parameters for version 1.1 are the same in the event tracking data 112 and the event logs 114, but a software error likely occurred for version 1.2 of the application 118, e.g., something doesn't align between the event tracking data 112 and the event logs for testing of version 1.2, the application analysis system 102 may determine that the software error is likely in the code for the application 118.

The application analysis system 102 may analyze event tracking data 112 and event logs 114 for multiple application executions when determining whether a software error likely occurred. For instance, the application analysis system 102 can analyze data for tens or hundreds of executions of the application 118 when determining, for the application 118, whether a software error likely occurred.

In some implementations, the application 118 may use the same test data for multiple executions of the application 118, e.g., for all executions of the application 118. For instance, when the application 118 presents content, e.g., an advertisement or a video or a picture, the application 118 may use the same content for multiple executions of the application 118 to generate consistent event tracking data for the third party system 122.

One or more of the time periods T₁, T₂, T₃, T₄ and T₅ may have different lengths, may overlap, or both. For instance, the device 116 may begin executing the application 118 at a first time. The application testing agent 120, while performing operations defined by a first script from the test scripts 106 during time period T₂, may cause the application 118 to provide first event tracking data A to the third party system 122 during time period T₃. The third party system 122 can analyze the received first event tracking data A to generate, and provide during time period T₄, first event tracking data B to the application analysis system. The application testing agent 120 may perform additional operations defined by the first test script during time period T₂ to cause the application to provide second event tracking data A to the third party system during time period T₃. After the device 116 stops executing the application 118, or minimizes the application 118 to the background, the device 116 may provide final event tracking data A to the third party system 122 during time period T₃. The third party system 122 may analyze the second and final event tracking data to generate and provide additional event tracking data B to the application analysis system 102 during time period T₄. The application analysis system 102 may then analyze the first event tracking data B and the additional event tracking data B to determine whether a software error likely occurred.

In some implementations, the device 116 may provide some of the event tracking data A to the third party system 122 after execution of the test scripts 106. In some implementations, the third party system may provide the event tracking data B to the application analysis system 102 on a period basis, e.g., hourly, daily, or weekly.

In some implementations, the application analysis system 102 and the third party system 122 are part of the same system. For instance, the system may use the application analysis system 102 to verify the accuracy of data for which the system has a direct measurement, e.g., receives data from the device 116. The system may verify the accuracy of the data when the system potentially allows execution of scripts in the application 118. For instance, the system may use the application analysis system 102 to perform black box testing to ensure that the event tracking data A, received from the device 116, is accurate.

In some implementations, the application 118 may provide the event tracking data A to the application analysis system 102. For instance, when a publisher of the application 118 controls the application analysis system 102, the application 118 may provide the event tracking data A directly to the application analysis system 102, e.g., when privacy controls for the application 118 indicate that a user has agreed to send the event tracking data A to the application analysis system 102. In these implementations, the application analysis system 102 does not necessarily need to receive the event tracking data B from the third party system 122. The application analysis system 102 may compare data from the event tracking data A with the event logs 114, during time period T₅ to detect whether a software error occurred.

In some implementations, the application 118 may allow the application analysis system 102 to run separate scripts within the application 118, e.g., when the application 118 has a corresponding privacy setting enabled by a user. The application analysis system 102 may use the application testing agent 120 to verify the accuracy of data gathered by scripts running within the application 118 to improve processes, such as machine learning processes, that use the data by comparing the data gathered by the scripts with the event logs 114.

The application analysis system 102 is an example of a system implemented as computer programs on one or more computers in one or more locations, in which the systems, components, and techniques described in this document are implemented. The device 116 may be a personal computer, mobile communication device, a virtual device, or another device that can send and receive data over a network 124. When the device 116 is a virtual device, the network 124 may be an internal network in the application analysis system 102, may include a portion of a network that connects with the third party system 122, or both. The network 124, such as a local area network (LAN), wide area network (WAN), the Internet, or a combination thereof, connects the application analysis system 102, the device 116, and the third party system 122. The application analysis system 102 may use a single server computer or multiple server computers operating in conjunction with one another, including, for example, a set of remote computers deployed as a cloud computing service.

For instance, the application analysis system 102 can include several different functional components, including the event collection apparatus 104, the event verification apparatus 108, and the content storage 110. The various functional components of the application analysis system 102 may be installed on one or more computers as separate functional components or as different modules of a same functional component. For example, the event collection apparatus 104, the event verification apparatus 108, the content storage 110, or a combination of two or more of these, can be implemented as computer programs installed on one or more computers in one or more locations that are coupled to each through a network. In cloud-based systems for example, these components can be implemented by individual computing nodes of a distributed computing system.

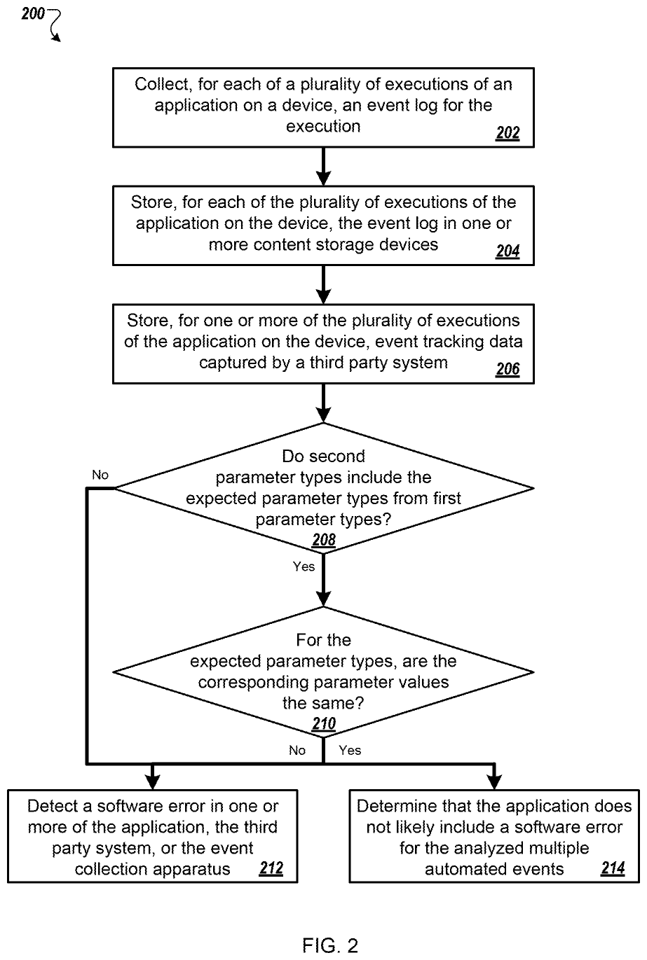

FIG. 2 is a flow diagram of a process 200 for detecting a software error. For example, the process 200 can be used by the application analysis system 102 from the environment 100.

An application analysis system collects, for each of a plurality of executions of an application on a device, an event log for the execution (202). For example, the application analysis system, e.g., an event collection apparatus included in the system, can send one or more test scripts to the device. The application analysis system may determine an event log for each of the test scripts. Some of the event logs may include data for multiple test scripts. Each of the test scripts may define operations for an application testing agent to perform during execution of the application. An event log that corresponds to the test script identifies application events and corresponding expected event parameters given the operations defined in the test script for the application testing agent to perform.

In some implementations, the application analysis system may collect multiple event logs for a single execution of the application. For instance, when the device, e.g., the application testing agent, executes multiple scripts during a single execution of the application, the application analysis system may collect one event log for each of the scripts, one event log for each script in a group of the scripts, e.g., when another single log identifies events for multiple of the scripts, or a combination of both.

Each event log may include, for each of multiple automated events that occurred on the device in response to one or more automated interactions performed by the application testing agent, one or more first parameter types and, for each of the first parameter types, a corresponding first parameter value. Some examples of parameter types include content type, content size, whether the content was presented on a display, link type, and whether content included a link. Some example parameter values true, false, a pixel size, or a link to the content.

The application analysis system stores, for each of the plurality of executions of the application on the device, the event log in one or more content storage devices (204). For example, the event collection apparatus can store the event log in a content storage that includes the one or more content storage devices. The content storage may be a database that includes one or more entries for each of the event logs.

The application analysis system stores, for one or more of the plurality of executions of the application on the device, event tracking data captured by a third party system (206). For instance, the application analysis system, e.g., the event collection apparatus, may receive event tracking data from a third party system that was received by the third party system in response to the application testing agent executing one or more of the scripts received by the device. The event tracking data can include, for each of at least some of the multiple automated events that occurred on the device, one or more second parameter types and, for each of the second parameter types, a corresponding second parameter value.

In some implementations, the application analysis system might not store any event tracking data for the plurality of executions of the application received from the third party system. For instance, when the application has a software error and does not send event tracking data to the third party system, or when the third party system has a software error and does not send event tracking data to the application analysis system, the application analysis system would not receive and store event tracking data.

The application analysis system determines whether the second parameter types include the expected parameter types from the first parameter types (208). For example, the application analysis system can store, in the event logs, multiple different parameters and parameter types that include both expected parameter types that should be included in the event tracking data and other metrics for execution of the application.

The event logs may include parameter types other than expected parameter types when the types of parameters identified by the event tracking data may change over time. For instance, the application analysis system may include an event log for each test script that an application testing agent may execute. The application analysis system may use the same event log for analysis of each time an application testing agent executes the test script. In case the event tracking data generated by the third party system may change, the application analysis system may include other parameter types in an event log so that an event log does not likely have to be updated based on changes to the third party system.

In response to determining that the second parameter types include the expected parameter types from the first parameter types, the application analysis system determines whether, for the expected parameter types, the corresponding parameter values the same (210). For example, the application analysis system, e.g., an event verification apparatus, compares the parameter values from the expected parameter types and the second parameter types. The application analysis system uses a result of the comparison to determine whether the parameter values for the expected parameter types are the same as the parameter values for the corresponding second parameter types. For instance, when both parameter types include a “content size” parameter type, the application analysis system determines whether the content size parameter value from the event logs is the same as the content size parameter value from the event tracking data.

In some implementations, the application analysis system may determine whether the corresponding parameter values are the same after determining that the second parameter types do not include all of the expected parameter types. For instance, the application analysis system may perform step 210 to determine more data that may identify a potential software error and whether there are additional discrepancies between the event log and the event tracking data for the execution of the application.

In response to determining that the second parameter types do not include all of the expected parameter types, that the corresponding parameter values are not the same, or both, the application analysis system detects a software error in one or more of the application, the third party system, or the event collection apparatus (212). For instance, the application analysis system, e.g., the event verification apparatus, uses the discrepancies between the expected parameter types and the second parameter types; discrepancies between the parameter values; or both, to detect the software error. The application analysis system may use the discrepancies to detect a potential location of the software error, e.g., the system in which the software error occurred, a potential software process in which the software error occurred, or both. A potential software process in which an error occurred may include content presentation, e.g., based on a size of content presented on a display.

The application analysis system, e.g., as part of a continual application development system, may provide data about a potential software error to a software debugging system. The data may identify a potential location of the software error. In some examples, the data may cause the software debugging system to automatically correct a software error without human input. For instance, the application analysis system may provide data to a third party system to cause the third party system to automatically correct the software error. The continual application development system may analyze each release of an application to prevent regressions during software updates, e.g., when bugs are accidentally introduced into the application code during an update.

In response to determining that the corresponding parameter values are the same, the application analysis system determines that the application does not likely include a software error for the analyzed multiple automated events (214). When the application analysis system determine that there is not likely a software error, the application analysis system may determine to skip further processing of the event logs, the event tracking data, or both, for the plurality of executions of the application. In some examples, the application analysis system may determine to remove the event logs, the event tracking data, or both, for the plurality of executions of the application from one or more memories.

The order of steps in the process 200 described above is illustrative only, and the detection of a software error can be performed in different orders. For example, the application analysis system may store the event tracking data before or concurrently with collection, storage, or both, of the event logs.

In some implementations, the process 200 can include additional steps, fewer steps, or some of the steps can be divided into multiple steps. For example, the application analysis system may maintain the event logs in the one or more content storage devices instead of collecting and storing the event logs. In some implementations, the application analysis system may perform one of steps 212 or 214, and not both, depending on results to the steps 208, 210, or both.

In some implementations, the application analysis system may use event tracking data generated during execution of the application on other devices when the application analysis system determines that there is not likely a software error. For instance, the application analysis system may use event tracking data during a machine learning training process, may analyze the event tracking data, or both. Verification that there is not likely a software error may improve an accuracy of event tracking data generated by other devices when the application analysis system cannot insert scripts into the application for execution on a device running the application. Improved accuracy of the event tracking data may improve accuracy of a machine learning process based on event tracking data generated by other devices.

For instance, when the application can receive both voice input and display input, e.g., mouse or touch input, the application may generate event tracking data about the accuracy of a speech recognition device used by the application. The application may provide the event tracking data to the third party system. The event tracking data may identify types of user input such as whether display input was required to correct inaccurate voice input, e.g., display selection of a comment user interface option after voice input to select the option. The application analysis system may use the event tracking data to identify errors in the speech recognition device, e.g., as part of a machine learning process, further training required for the speech recognition device, or another way in which to improve the application based on the event tracking data. The application analysis system may use the methods and systems described in this document to increase a likelihood that the event tracking data captured by the third party system is complete and accurate, to better improve the application, the machine learning process, e.g., the speech recognition device, or both.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HyperText Markup Language (HTML) page, to a user device, e.g., for purposes of displaying data to and receiving user input from a user interacting with the user device, which acts as a client. Data generated at the user device, e.g., a result of the user interaction, can be received from the user device at the server.

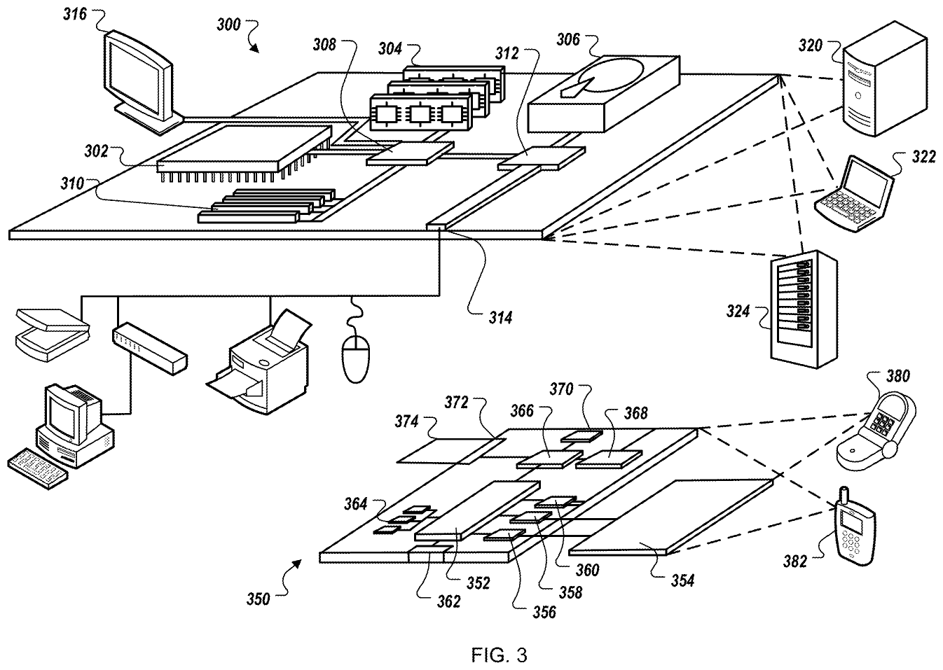

FIG. 3 is a block diagram of computing devices 300, 350 that may be used to implement the systems and methods described in this document, as either a client or as a server or plurality of servers. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a computer-readable medium. In one implementation, the memory 304 is a volatile memory unit or units. In another implementation, the memory 304 is a non-volatile memory unit or units.

The storage device 306 is capable of providing mass storage for the computing device 300. In one implementation, the storage device 306 is a computer-readable medium. In various different implementations, the storage device 306 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of duties is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can process instructions for execution within the computing device 350, including instructions stored in the memory 364. The processor may also include separate analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT LCD display or an OLED display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provided in communication with processor 352, so as to enable near area communication of device 350 with other devices. External interface 362 may provide, for example, for wired communication (e.g., via a docking procedure) or for wireless communication (e.g., via Bluetooth or other such technologies).

The memory 364 stores information within the computing device 350. In one implementation, the memory 364 is a computer-readable medium. In one implementation, the memory 364 is a volatile memory unit or units. In another implementation, the memory 364 is a non-volatile memory unit or units. Expansion memory 374 may also be provided and connected to device 350 through expansion interface 372, which may include, for example, a SIMM card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provided as a security module for device 350, and may be programmed with instructions that permit secure use of device 350. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352.

Device 350 may communicate wirelessly through communication interface 366, which may include digital signal processing circuitry where necessary. Communication interface 366 may provide for communications under various modes or protocols, such as GSM voice calls, SMS, EMS, or MIMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS receiver module 370 may provide additional wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smartphone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computing system comprising:
one or more content storage devices;
an event collection apparatus implemented on one or more computers that is configured to perform operations including:
collecting, for each of a plurality of executions of an application on a device, an event log for the execution that identifies automated interactions with the application performed by an application testing agent on the device, each event log comprising, for each of multiple automated events that occurred on the device in response to one or more of the automated interactions, one or more first parameter types and, for each of the first parameter types, a corresponding first parameter value;
storing, for each of the plurality of executions of the application on the device, the event log in the one or more content storage devices; and
storing, for one or more of the plurality of executions of the application on the device and in the one or more content storage devices, event tracking data captured by a third party system, separate from an event verification apparatus, during the automated interaction with the application on the device by the application testing agent, the event tracking data comprising, for each of at least some of the multiple automated events that occurred on the device, one or more second parameter types and, for each of the second parameter types, a corresponding second parameter value; and
the event verification apparatus implemented on one or more computers that is configured to interact with the one or more content storage devices and perform operations comprising:
comparing, for some of the plurality of executions of the application, the first parameter types with the second parameter types to determine whether expected parameter types from the first parameter types are included in the second parameter types;
comparing, for each of the expected parameter types that are included in the second parameter types, the corresponding first parameter values with the corresponding second parameter values for the same parameter type to determine whether the corresponding values are the same; and
detecting a software error in one or more of the application, the third party system, or the event collection apparatus in response to determining that i) at least one of the expected parameter types from first parameter types is not included in the second parameter types, ii) at least one of the corresponding values is not the same, or iii) both i and ii.

2. The computing system of claim 1, wherein the event collection apparatus is configured to perform operations comprising:
receiving, via a network from a device, an event log generated by the device during automated interaction with an application on the device; and
storing, in the one or more content storage devices, the event log.

3. The computing system of claim 1, wherein the event collection apparatus is configured to perform operations comprising:
receiving, via a network from the third party system, the event tracking data; and
storing, in the one or more content storage devices, the event tracking data.

4. The computing system of claim 1, wherein the application prevents the application from executing scripts from other systems, including the event collection apparatus and the event verification apparatus, during execution of the application.

5. The computing system of claim 4, wherein the application is a web-based application.

6. The computing system of claim 1, wherein:
the event collection apparatus is configured to perform operations comprising:
selecting, from a database of multiple test scripts, a test script that identifies multiple automated interactions with the application;
providing, to the device, the test script to cause the application testing agent to perform one or more of the multiple automated interactions with the application; and
receiving, from the device, a message indicating that the application testing agent executed the test script; and
collecting, for at least one of the plurality of executions of the application on the device, the event log comprises:
selecting a log that identifies the multiple automated events that execution of the test script by the application testing agent is likely to cause to occur on the device; and
in response to receiving the message indicating that the application testing agent executed the test script, using the selected log as the event log for the execution of the test script by the application testing agent.

7. The computing system of claim 1, wherein collecting, for at least one of the plurality of executions of the application on the device, the event log comprises receiving the event log from the device that the application testing agent created concurrently with execution of a test script that defined multiple automated interactions for the application testing agent to perform with the application.

8. The computing system of claim 1, wherein the event collection apparatus is configured to perform operations comprising:
providing, to the device, a test script that identifies specific automated interactions for the application testing agent to perform to test a particular type of event in the application.

9. The computing system of claim 1, wherein the event collection apparatus is configured to perform operations comprising:
providing, to the device for each event type in a plurality of event types, a test script that identifies specific automated interactions for the application testing agent to perform to test the corresponding event type in the application.

10. The computing system of claim 1, wherein the event verification apparatus is configured to perform operations comprising:
determining that the one or more content storage devices include an event log for a particular execution of the application from the plurality of executions;
determining that the one or more content storage devices do not include event tracking data for the particular execution of the application that was captured by the third party system; and
in response to determining that the one or more content storage devices include an event log for a particular execution and determining that the one or more content storage devices do not include event tracking data for the particular execution, detecting a software error for the application or the third party system or both.

11. The computing system of claim 1, wherein detecting the software error comprises determining a potential location of a software error using i) the at least one of the expected parameter types from first parameter types is not included in the second parameter types, ii) the at least one of the corresponding values is not the same, or iii) both i and ii.

12. The computing system of claim 11, wherein the event verification apparatus is configured to perform operations comprising:
in response to determining the potential location of the software error, sending, to a software debugging system, data that identifies the potential location of the software error.

13. The computing system of claim 11, wherein the event verification apparatus is configured to perform operations comprising:
in response to determining the potential location of the software error, sending, to a software debugging system, data that identifies the potential location of the software error to cause the software debugging system to automatically, without human input, correct the software error.

14. A computer-implemented method comprising:
collecting, by an event collection apparatus and for each of a plurality of executions of an application on a device, an event log for the execution that identifies automated interactions with the application performed by an application testing agent on the device, each event log comprising, for each of multiple automated events that occurred on the device in response to one or more of the automated interactions, one or more first parameter types and, for each of the first parameter types, a corresponding first parameter value;
storing, by the event collection apparatus and for each of the plurality of executions of the application on the device, the event log in one or more content storage devices;
storing, by the event collection apparatus and for one or more of the plurality of executions of the application on the device and in the one or more content storage devices, event tracking data captured by a third party system, separate from an event verification apparatus, during the automated interaction with the application on the device by the application testing agent, the event tracking data comprising, for each of at least some of the multiple automated events that occurred on the device, one or more second parameter types and, for each of the second parameter types, a corresponding second parameter value;
comparing, by the event verification apparatus and for some of the plurality of executions of the application, the first parameter types with the second parameter types to determine whether expected parameter types from the first parameter types are included in the second parameter types;
comparing, by the event verification apparatus and for each of the expected parameter types that are included in the second parameter types, the corresponding first parameter values with the corresponding second parameter values for the same parameter type to determine whether the corresponding values are the same; and
detecting, by the event verification apparatus, a software error in one or more of the application, the third party system, or the event collection apparatus in response to determining that i) at least one of the expected parameter types from first parameter types is not included in the second parameter types, ii) at least one of the corresponding values is not the same, or iii) both i and ii.

15. The method of claim 14, comprising:
receiving, by the event collection apparatus via a network and from a device, an event log generated by the device during automated interaction with an application on the device; and
storing, by the event collection apparatus and in the one or more content storage devices, the event log.

16. The method of claim 14, comprising:
receiving, by the event collection apparatus via a network and from the third party system, the event tracking data; and
storing, by the event collection apparatus and in the one or more content storage devices, the event tracking data.

17. The method of claim 14, wherein the application prevents the application from executing scripts from other systems, including the event collection apparatus and the event verification apparatus, during execution of the application.

18. The method of claim 17, wherein the application is a web-based application.

19. The method of claim 14, comprising:
selecting, by the event collection apparatus and from a database of multiple test scripts, a test script that identifies multiple automated interactions with the application;
providing, by the event collection apparatus and to the device, the test script to cause the application testing agent to perform one or more of the multiple automated interactions with the application; and
receiving, by the event collection apparatus and from the device, a message indicating that the application testing agent executed the test script; wherein:
collecting, for at least one of the plurality of executions of the application on the device, the event log comprises:
selecting a log that identifies the multiple automated events that execution of the test script by the application testing agent is likely to cause to occur on the device; and
in response to receiving the message indicating that the application testing agent executed the test script, using the selected log as the event log for the execution of the test script by the application testing agent.

20. A non-transitory computer storage medium encoded with instructions that, when executed by one or more computers, cause the one or more computers to perform operations comprising:
collecting, by an event collection apparatus and for each of a plurality of executions of an application on a device, an event log for the execution that identifies automated interactions with the application performed by an application testing agent on the device, each event log comprising, for each of multiple automated events that occurred on the device in response to one or more of the automated interactions, one or more first parameter types and, for each of the first parameter types, a corresponding first parameter value;
storing, by the event collection apparatus and for each of the plurality of executions of the application on the device, the event log in one or more content storage devices;
storing, by the event collection apparatus and for one or more of the plurality of executions of the application on the device and in the one or more content storage devices, event tracking data captured by a third party system, separate from an event verification apparatus, during the automated interaction with the application on the device by the application testing agent, the event tracking data comprising, for each of at least some of the multiple automated events that occurred on the device, one or more second parameter types and, for each of the second parameter types, a corresponding second parameter value;
comparing, by the event verification apparatus and for some of the plurality of executions of the application, the first parameter types with the second parameter types to determine whether expected parameter types from the first parameter types are included in the second parameter types;
comparing, by the event verification apparatus and for each of the expected parameter types that are included in the second parameter types, the corresponding first parameter values with the corresponding second parameter values for the same parameter type to determine whether the corresponding values are the same; and
detecting, by the event verification apparatus, a software error in one or more of the application, the third party system, or the event collection apparatus in response to determining that i) at least one of the expected parameter types from first parameter types is not included in the second parameter types, ii) at least one of the corresponding values is not the same, or iii) both i and ii.
